(19) United States
(12) Patent Application Publication
(10) Pub. No.: US 2018/0047029 A1
(43) Pub. Date: Feb. 15, 2018

(54) CUSTOMER SERVICE DEVICE, CUSTOMER SERVICE METHOD, AND CUSTOMER SERVICE SYSTEM

(71) Applicant: Panasonic Intellectual Property Management Co., Ltd., Osaka (JP)

(72) Inventors: ATSUSHI SASO, Kanagawa (JP); NAOMI TOMIYAMA, Kyoto (JP); YUICHI AOKI, Osaka (JP); MOTOJI OHMORI, Osaka (JP)

(21) Appl. No.: 15/652,280

(22) Filed: Jul. 18, 2017

(30) Foreign Application Priority Data
Aug. 10, 2016 (JP) 2016-157464

(51) Int. Cl. G06Q 30/00

(52) U.S. Cl. CPC G06Q 30/016

(57) ABSTRACT

A customer service device includes: a communicator that receives a control command including response content information that indicates response content to be subsequently carried out to a customer, the response content being handed over from a customer service person who has served the customer, and first note information that indicates a first note to be considered in serving the customer; and a service determiner that, based on the control command, determines a response to the customer so as to carry out the response content indicated by the response content information according to the first note information.

### BACKGROUND

### 1. Technical Field

The present disclosure relates to a customer service device, a customer service method for the customer service device, and a customer service system that, after a customer service person serves a customer, provide the subsequent service that is handed over from the customer service person. The present disclosure relates to a technique of handing over a subsequent service from a customer service person to a robot after the customer service person serves a customer, for instance, in a hotel or a store.

### 2. Description of the Related Art

In recent years, due to the development of artificial intelligence, various service jobs such as a reception job, and a guidance job are increasingly performed by a robot rather than a human. Such service jobs are performed in a retail store, a bank, a hotel, a medical facility, a nursing-care facility, a school, a manufacturing factory, and other various facilities.

For instance, Japanese Unexamined Patent Application Publication No. 2009-131914 discloses the following. First, a robot transmits operation history information on communication behavior to a central control unit. The central control unit builds an individual behavior transition database (DB), an age and sex-dependent behavior transition DB, and a location-dependent behavior transition DB based on history information on remote operation out of the operation history information from the robot. The robot selects a DB according to the name, age and sex, or location of a conversation partner. The robot refers to the selected DB, and determines a subsequent communication behavior based on a command indicating the current operation of the robot, and operation history information matching the behavior of the conversation partner in response to the operation of the robot. Japanese Unexamined Patent Application Publication No. 2009-131914 claims that the number of remote operations performed by an operator can be reduced as much as possible because the robot performs an autonomous behavior based on the operation history information on remote control.

Also, Japanese Unexamined Patent Application Publication No. 2007-190641 discloses the following. A communication robot includes various sensors that detect the surrounding and the condition of the robot, and determines whether or not an operator call condition is satisfied, based on the outputs of the sensors. Normally, a communication robot performs a communication behavior with a human by autonomous control to provide services such as reception and guidance. When determining that an operator call condition is satisfied, the communication robot transmits a call request to an operator terminal via a network. In response to the call request, an operator operates the operator terminal to transmit a control command to the communication robot. The communication robot performs a communication behavior in accordance with the control command. Japanese Unexamined Patent Application Publication No. 2007-190641 claims that appropriate service can be provided efficiently.

### SUMMARY

One non-limiting and exemplary embodiment provides a customer service device, a customer service method, and a customer service system that, after a customer service person serves a customer, allow the subsequent service to be smoothly handed over from the customer service person to the customer service device.

In one general aspect, the techniques disclosed here feature a customer service device comprising: a communicator that receives a control command including response content information that indicates response content to be subsequently carried out to a customer, the response content being handed over from a customer service person who has served the customer, and first note information that indicates a first note to be considered in serving the customer; and a service determiner that, based on the control command, determines a response to the customer so as to carry out the response content indicated by the response content information according to the first note information.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating an example of a configuration of a customer service system according to an embodiment of the present disclosure;

FIG. 2 is a table illustrating an example of behavior rules stored in a behavior rule storage of a robot illustrated in FIG. 1;

FIG. 3 is a sequence diagram illustrating an example of service processing performed by a customer service system illustrated in FIG. 1;

FIG. 4 is a window illustrating an example of an input screen for a customer service person to input hand-over information using the tablet illustrated in FIG. 1;

FIG. 5 is a table illustrating an example of a data structure of a control command transmitted from the tablet to the robot illustrated in FIG. 1; and

FIG. 6 is a flowchart illustrating an example of service hand-over processing performed by the robot illustrated in FIG. 1.

### DETAILED DESCRIPTION

### (Underlying Knowledge Forming Basis of the Present Disclosure)

The capability of robots in communicating with humans is improving daily, and it is expected that robots increasingly replace human workers and perform a communication job such as a service to a customer (human) in the near future. However, a robot does not have such a communication capability of completely understanding the emotion of a human and providing complete customer service, and thus it is difficult for the robot to provide all services as a substitute for a human. For this reason, it is productive that a human (customer service person) serves a customer at first, and knowledge about the customer obtained by the customer service person is transmitted to a robot in a manner in which the knowledge is appropriately processable.

However, in the above-described technique in the related art, after a customer service person serves a customer, no consideration is given as to how a subsequent service is handed over from the customer service person to a customer service device such as a communication robot. Thus, after a customer service person serves a customer, it is difficult to smoothly hand over a subsequent service from the customer service person to a customer service device.

Here, when the service to the customer is handed over from the customer service person to a robot, the customer service person considers the need and intention of the customer to determine a plan for the service, and teaches the robot the plan for the service, thereby allowing the service to the customer to be handed over to the robot based on the plan for the service.

Based on the above-mentioned underlying knowledge, the inventors have intensively studied how a subsequent service should be handed over from a human (customer service person) to a robot (a customer service device) after the human (customer service person) serves a customer. As a result, the present disclosure has been completed.

The outline of an aspect of the present disclosure is as follows.

### [Item 1]

A customer service device comprising: a communicator that receives a control command including response content information that indicates response content to be subsequently carried out to a customer, the response content being handed over from a customer service person who has served the customer, and first note information that indicates a first note to be considered in serving the customer and a service determiner that, based on the control command, determines a response to the customer so as to carry out the response content indicated by the response content information according to the first note information.

With the configuration of Item 1, when a control command is received, which includes response content information indicating response content that is handed over from a customer service person to a customer service device, and first note information (also called hand-over time service note information) that indicates a note to be considered when the customer is served, a response to be provided to the customer is determined to carry out the response content indicated by the response content information in accordance with the note indicated by the hand-over time service note information. Thus, the response reflecting the note determined by the customer service person in consideration of the need and intention of the customer can be provided to the customer. Consequently, after the customer service person serves the customer, a subsequent service can be smoothly handed over from the customer service person to the customer service device.

### [Item 2]

The customer service device according to Item 1, further comprising a first storage that stores, in advance, the first note information and behavior rule information in association with each other, the behavior rule information indicating a behavior rule to be obeyed in serving the customer, wherein the service determiner refers to the first storage and determines the response to the customer so as to carry out the response content indicated by the response content information according to the behavior rule information associated with the first note information included in the control command.

With the configuration of Item 2, a response to be provided to the customer is determined to achieve the response content indicated by the response content information in accordance with the specific behavior rule information associated with the note indicated by the hand-over time service note information. Thus, appropriate response can be provided to the customer in consideration of the note.

### [Item 3]

The customer service device according to Item 2, further comprising: a biological data detector that acquires biological data of the customer; and a generator that generates second note information that indicates a second note to be considered in serving the customer, the second note being determined by analyzing the biological data acquired by the biological data detector, wherein the first storage stores, in advance, the second note information and the behavior rule information in association with each other, and when the second note information is different from the first note information, the service determiner refers to the first storage and determines the response to the customer so as to carry out the response content indicated by the response content information according to the behavior rule information associated with the second note information.

With the configuration of Item 3, second note information (also called customer service note information) indicating service note information to be considered by the customer service device when the customer is served is generated from the biological data acquired when the customer is served. Thus, a note matching the current state of the customer can be generated. Also, when the customer service note information is different from the hand-over time service note information, a response to be provided to the customer is determined to achieve the response content indicated by the response content information in accordance with a behavior rule associated with the customer service note information. Thus, appropriate response can be provided to the customer in consideration of the note matching the current state of the customer.

### [Item 4]

The customer service device according to Item 3, further comprising a second storage that stores identification information and history information in association with each other, the identification information identifying the customer, the history information including a third note information indicating a third note considered in serving the customer before, wherein the control command further includes the identification information, and when the second note information is different from the first note information, the service determiner replaces the third note information associated with the identification information included in the control command with the second note information.

With the configuration of Item 4, the hand-over time service note information stored in a history storage is updated to the customer service note information acquired from the current state of the customer. Thus, it is possible to update to a note matching the current state of the customer and to provide appropriate response to the customer in consideration of the latest note all the time by referring to the history storage.

### [Item 5]

The customer service device according to Item 4, further comprising an adder that adds the history information associated with the identification formation included in the control command to the control command, wherein the service determiner determines the response to the customer so as to carry out the response content indicated by the response content information according to the behavior rule information associated with the second note information, based on the history information.

With the configuration of Item 5, history information stored in the history storage is added to the control command, and a response to be provided to the customer is determined to carry out the response content indicated by the response content information in accordance with the behavior rule associated with the hand-over time service note information and the customer service note information, in consideration of the history information. Thus, appropriate response can be provided to the customer according to the past history.

### [Item 6]

The customer service device according to any one of Items 2 to 5, wherein the control command further includes crucial condition information indicating that an attribute of the customer satisfies a predetermined crucial condition, the first storage stores, in advance, the crucial condition information and the behavior rule information in association with each other, and when the control command includes the crucial condition information, the service determiner refers to the first storage and determines the response to the customer to carry out the response content indicated by the response content information according to the behavior rule associated with the crucial condition information included in the control command.

With the configuration of Item 6, when the attribute of the customer satisfies a predetermined crucial condition, a response to be provided to the customer is determined in accordance with the behavior rule associated with the crucial condition information. Thus, a special response can be provided to only important customers to the service staff.

### [Item 7]

The customer service device according to any one of Items 2 to 6, wherein when the service determiner determines that support by the customer service person is necessary according to the behavior rule associated with the first note information included in the control command, the service determiner generates support request information indicating necessity of the support by the customer service person, and the communicator transmits the support request information to a communication terminal owned by the customer service person.

With the configuration of Item 7, when it is determined that support by the customer service person is necessary in accordance with the behavior rule associated with the hand-over time service note information included in the control command, support request information that indicates necessity of support by the service staff is generated. Thus, when response to the customer cannot be smoothly provided by the customer service device, necessity of support by the customer service person can be presented to the communication terminal, and the response to the customer can be urgently handed over from the customer service device to the customer service person.

### [Item 8]

The customer service device according to any one of Items 1 to 7, further comprising a service executor that executes the response determined by the determiner to the customer.

### [Item 9]

The customer service device according to Item 8, wherein the service executor executes the response to the customer by using at least one of a sound, an image, and a body movement.

With the configuration of Item 9, a robot can provide appropriate response using at least one of a sound, an image, and a body movement.

Also, the present disclosure can be implemented not only as a customer service device in a characteristic configuration as described above, but also as a customer service method for performing characteristic processing corresponding to the characteristic configuration of the customer service device. Also, a robot may include part of the components of the customer service device of the present disclosure, other components may include a communication terminal or a server configured to be communicable with the robot, and a customer service system including such a robot and a communication terminal may be configured. Thus, the same effect as the effect of the customer service device described above can be provided even in the following aspects.

### [Item 10]

A customer service method comprising: receiving a control command including response content information that includes response content to be subsequently carried out to the customer, the response content information being handed over from a customer service person who serves the customer, and first note information that indicates a first note to be considered in serving the customer; and determining a response to the customer so as to carry out the response content according to the first note information.

### [Item 11]

A customer service system comprising: a communication terminal owned by a customer service person who serves a customer; and a customer service device that serves the customer, wherein the communication terminal includes a first communicator that transmits a control command including response content information that indicates response content to be subsequently carried out to the customer, the response content being handed over from the customer service person who has served the customer to the service device, and first note information that includes a first note to be considered in serving the customer, and the customer service device includes a second communicator that receives the control command, and a service determiner that, based on the control command, determines a response to the customer so as to carry out the response content indicated by the response content information according to the first note information.

Also, the present disclosure may be implemented as a computer program that causes a computer to execute the characteristic processing included in the customer service method described above. It goes without saying that such a computer program can be distributed via a non-transitory computer-readable recording medium such as a CD-ROM or a communication network such as the Internet.

It is to be noted that each of the embodiments described below illustrates a specific example of the present disclosure. The numerical values, shapes, components, steps, and order of the steps that are presented in the following embodiments are examples, which are not intended to limit the present disclosure. In the following embodiments, the components thereof, which are not described in the independent claim that defines the most generic concept of the present disclosure, are regarded as any components. Also, in all embodiments, respective configurations may be combined.

### Embodiment

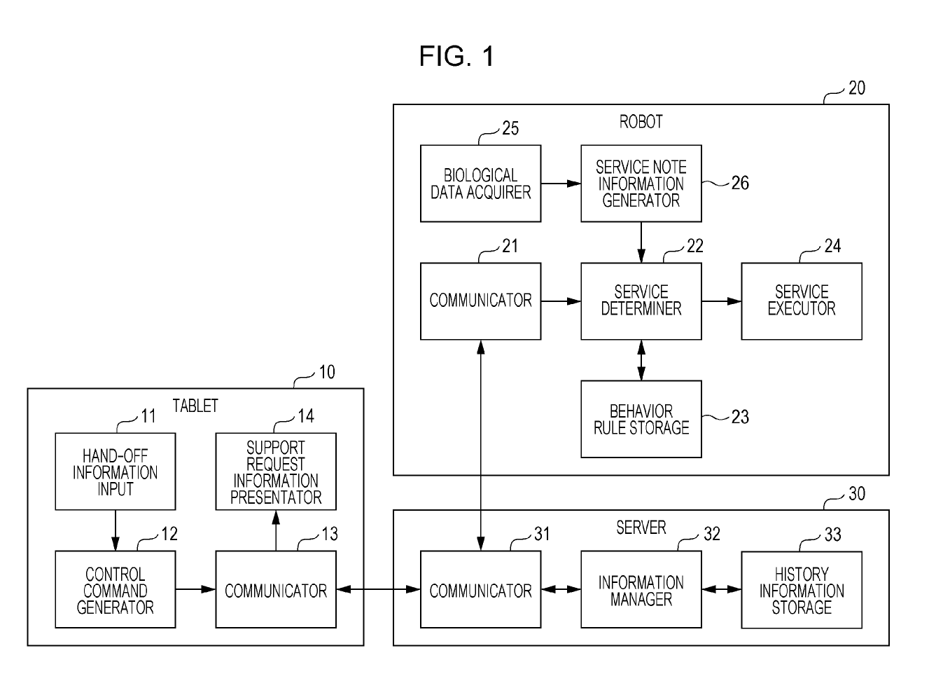

Hereinafter, an embodiment of the present disclosure will be described with reference to the drawings. FIG. 1 is a block diagram illustrating an example of a configuration of a customer service system according to an embodiment of the present disclosure. The customer service system illustrated in FIG. 1 includes a tablet 10, a robot 20, and a server 30.

The tablet 10 is an example of a communication terminal owned, carried, or used by a customer service person who serves a customer. Here, a customer and a customer service person are normally humans. The tablet 10 is connected to the server 30 to allow communication therebetween via a wired or wireless communication line (not illustrated). The robot 20 is a humanoid robot, i.e., a machine that serves a customer using at least one of a sound, an image, and a body movement. The server 30 is connected to the tablet 10 and the robot 20 to allow communication therebetween via a wired or wireless communication line (not illustrated).

The tablet 10 includes a hand-over information input 11, a control command generator 12, a communicator 13 and a support request information presentator 14. The robot 20 includes a communicator 21, a service determiner 22, a behavior rule storage 23, a service executor 24, a biological data detector 25, and a service note information generator 26. The server 30 includes a communicator 31, an information manager 32, and a history information storage 33.

Here, the communicator 21 represents an example of the communicator of the customer service device. The service determiner 22 represents an example of the service determiner. The behavior rule storage 23 represents an example of the first storage. The biological data detector 25 represents an example of the biological data detector. The service note information preparing part 26 represents an example of the generator. The history information storage 33 represents an example of the second storage. The information manager 32 represents an example of the adder. The communicator 13 represents an example of the communicator of a communication terminal.

The hand-over information input 11 of the tablet 10 includes a touch panel, and is used by a customer service person for inputting hand-over information. The hand-over information includes response content information indicating response content that is handed over from the customer service person to the robot 20, and hand-over time service note information that indicates a note to be considered by the robot 20 when a customer is served. Also, the hand-over information may include crucial condition information that indicates that the attribute of the customer satisfies a predetermined crucial condition, and identification information that identifies the customer. The crucial condition information indicates, for instance, that the customer is a premium customer registered as an important customer. The identification information is, for instance, a user ID.

It is to be noted that the configuration of the hand-over information input 11 is not particularly limited to the above-described example, and various modifications are possible such as inputting hand-over information by using an input device such as a keyboard, or by voice recognition of the voice of a customer service person using a microphone.

The control command generator 12 generates a control command for controlling the robot 20 based on the hand-over information inputted from the hand-over information input 11. The control command includes response content information indicating response content that is handed over from the customer service person to the robot 20, and hand-over time service note information that indicates a note to be considered by the robot 20 when a customer is served. In addition, the control command may include the crucial condition information and the identification information mentioned above.

The communicator 13 performs communication between the server 30 and the tablet 10, transmits various information generated by the tablet 10 to the communicator 31, and receives various information generated by the server 30 from the communicator 31. Here, the various information generated by the server 30 also includes various information generated by the robot 20. Specifically, the communicator 13 transmits a control command generated by the control command generator 12 to the server 30.

The communicator 31 of the server 30 performs communication between the server 30 and the robot 20 in addition to the communication with the tablet 10, transmits various information generated by the server 30 to the communicator 21, and receives various information generated by the robot 20 from the communicator 21.

The history information storage 33 stores history information indicating past service history of each customer in association with the user ID of the customer. The history information includes the past service situation to the customer by the robot 20 or the customer service person, and hand-over information from the customer service person to the robot 20. The hand-over information includes hand-over time service note information in the past service to the customer.

When a control command to a customer, for whom history information is stored in the history information storage 33, is inputted, the information manager 32 reads the history information of the customer from the history information storage 33, and adds the history information to the control command.

Specifically, a control command transmitted from the tablet 10 is inputted to the information manager 32 via the communicator 31. The information manager 32 checks whether or not the history information on the user ID included in the control command is stored in the history information storage 33. When the history information on the user ID included in the control command is stored in the history information storage 33, the information manager 32 adds the history information on the user ID included in the control command to the control command, and transmits the control command to the robot 20 via the communicator 31. On the other hand, when the history information on the user ID included in the control command is not stored in the history information storage 33, the information manager 32 transmits the control command to the robot 20 as it is via the communicator 31. It is to be noted that when processing such as the above-described addition of history information to the control command is not performed by the server 30, the control command may be directly transmitted from the communicator 13 of the tablet 10 to the communicator 21 of the robot 20 without passing via the server 30 (the communicator 31).

The communicator 21 of the robot 20 performs communication between the robot 20 and the server 30. The communicator 21 transmits various information generated by the robot 20 to the communicator 31, and receives various information generated by the server 30 from the communicator 31.

When the communicator 21 receives a control command, the service determiner 22 determines a response to be provided to the customer to carry out the response content indicated by the response content information in accordance with the a note indicated by the hand-over time service note information included in the control command. Specifically, the service determiner 22 refers to the behavior rule storage 23, and determines a response to be provided to the customer in accordance with the behavior rule information associated with the hand-over time service note information included in the control command.

The behavior rule storage 23 pre-stores behavior rule information in association with hand-over time service note information, the behavior rule information indicating a behavior rule to be obeyed out by the robot 20 when the hand-over time service note information is received.

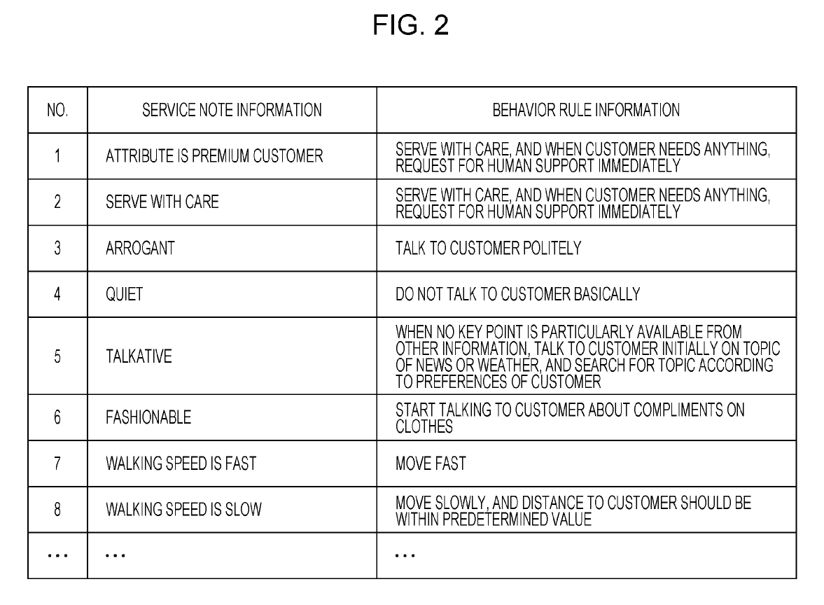

FIG. 2 is a table illustrating an example of behavior rules stored in the behavior rule storage 23 of the robot 20 illustrated in FIG. 1. As illustrated in FIG. 2, an identification number (“No”) is assigned to each service note information, and a piece of service note information and behavior rule information are stored in association with each other for each number.

Here, the service note information includes the case of the above-mentioned hand-over time service note information, and the case of the later-described customer service note information. A plurality of pieces of service note information is pre-stored as the hand-over time service note information and the customer service note information to be used by the robot 20. It is to be noted that a number is assigned to each service note information, specifically, an identification number is assigned to each service note information. Thus, the customer service person may set the hand-over time service note information by inputting a number for each service note information without directly inputting each service note information.

In the example illustrated in FIG. 2, the service note information, for instance, for “No. 1” is information that “ATTRIBUTE IS PREMIUM CUSTOMER”. The behavior rule information for the service note information is “SERVE WITH CARE, AND WHEN THE CUSTOMER NEEDS ANYTHING, REQUEST FOR HUMAN SUPPORT IMMEDIATELY”. In this case, since the customer is a premium customer, the robot 20 serves the customer with care in all responses to the customer, and when a problem occurs such as the customer gets angry, the robot 20 transmits support request information requesting for support of a customer service person to the tablet 10.

Next, the service note information for “No. 2” is information that “SERVE WITH CARE”. The behavior rule information for the service note information is “SERVE WITH CARE, AND WHEN THE CUSTOMER NEEDS ANYTHING, REQUEST FOR HUMAN SUPPORT IMMEDIATELY”. In this case, when the customer is not a premium customer, service is provided with care in the same manner as described above.

Next, the service note information for “No. 3” is information that the customer has an “ARROGANT” attitude. The behavior rule information for the service note information is “TALK TO THE CUSTOMER POLITELY”. In this case, the robot 20 has conversation with the customer using polite words.

Next, the service note information for “No. 4” is information that the customer has a “QUIET” atmosphere. The behavior rule information for the service note information is “DO NOT TALK TO THE CUSTOMER BASICALLY”. In this case, when talked by the customer, the robot 20 provides a response.

Next, the service note information for “No. 5” is information that the customer has “TALKATIVE” character. The behavior rule information for the service note information is “WHEN NO KEY POINT IS PARTICULARLY AVAILABLE FROM OTHER INFORMATION, TALK TO THE CUSTOMER INITIALLY ON THE TOPIC OF NEWS OR WEATHER, AND SEARCH FOR A TOPIC ACCORDING TO THE PREFERENCES OF THE CUSTOMER”. In this case, when a topic in which the customer may be interested is found from the past history information, the robot 20 talks to the customer with the topic. When such a topic is not found, the robot 20 talks to the customer initially on the topic of news or weather. Like this, the robot 20 talks to the customer in a positive manner.

Next, the service note information for “No. 6” is information that the customer is “FASHIONABLE”. The behavior rule information for the service note information is “START TALKING TO THE CUSTOMER ABOUT COMPLIMENTS ON CLOTHES”. In this case, the robot 20 starts conversation by complimenting the customer on clothes.

Next, the service note information for “No. 7” is information that the customer has a “FAST WALKING SPEED”. The behavior rule information for the service note information is “MOVE FAST”. In this case, the robot 20 serves the customer while moving quickly according to the movement of the customer.

Next, the service note information for “No. 8” is information that the customer has a “slow walking speed”. The behavior rule information for the service note information is “MOVE SLOWLY, AND DISTANCE TO THE CUSTOMER SHOULD BE WITHIN A PREDETERMINED VALUE”. In this case, the robot 20 serves the customer while moving slowly to keep the distance to the customer within a certain value (for instance, within 1 m) all the time.

It is to be noted that the service note information and the behavior rule information are not particularly limited to the above-described example, and various modifications may be made. For instance, when the attribute of the customer is detected to be a child and the service note information is that the customer is a child, the robot 20 may bend down to the height of the child to serve the child.

Again, FIG. 1 is referred to. The service executor 24 provides specific response based on the response determined by the service determiner 22. For instance, the service executor 24 includes a microphone, and a speaker, obtains the voice of a customer, recognizes the obtained voice, generates a reply to an inquiry from the customer, and converts the generated reply to voice and speaks. It is to be noted that the configuration of the service executor 24 is not particularly limited to the above-described example, and various modifications may be made, for instance, a reply to an inquiry from the customer is displayed using a display or the like. Also, in addition to the voice reply by the service executor 24, the robot 20 may make a body movement suitable for the content of the reply.

The biological data detector 25 acquires the biological data of the customer. Specifically, the biological data detector 25 is equipped with a sensor that measures the pulse wave of a human in a non-contact manner by using a highly sensitive spread spectrum millimeter-wave radar, and detects the cardiac rate and the cardiac rate variability of the customer. In addition, the biological data detector 25 is equipped with a camera, a microphone, and acquires image data captured from the customer as biological data.

It is to be noted that the configuration of the biological data detector 25 is not particularly limited to this example. A smartwatch that measures human vital data may be attached to the customer, and the vital data and the like may be acquired from the smartwatch. Also, the biological data acquired by the biological data detector 25 is also not particularly limited to the above-mentioned pulse wave and image, and other biological data such as voice, a face image, a blood oxygen level, a blood pressure, a body temperature may be used. In this case, the biological data detector 25 is configured to be able to acquire each biological data.

The service note information generator 26 analyzes the biological data acquired by the biological data detector 25, and thereby generates customer service note information that indicates a note to be considered by the robot 20 when the customer is served, and outputs the customer service note information to the service determiner 22.

For instance, the service note information generator 26 guesses the emotion of the customer as one of “anger”, “delight”, “sadness”, and “pleasure” from a pulse wave acquired by the biological data detector 25 (see, for instance, Japanese Patent No. 5257525), and when it is determined that the emotion is likely to be “anger”, the service note information generator 26 generates customer service note information that indicates “serve with care”.

Also, the service note information generator 26 detects the walking speed of the customer from an image acquired by the biological data detector 25. When the walking speed is fast, the service note information generator 26 generates customer service note information indicating that “walking speed is fast”, and when the walking speed is slow, the service note information generator 26 generates customer service note information indicating that “walking speed is slow”.

It is to be noted that a method for generating customer service note information using biological data is not particularly limited to the above-described example. For instance, the emotion of the customer may be identified using a consciousness level and a comfort level of the customer generated from biological sensor values (see, for instance, Japanese Patent No. 5735592). Also, for instance, the expression or the tone of voice of the customer is analyzed, and the emotion and thought may be estimated. In this manner, various modifications may be made such as generating customer service note information to be considered for the customer.

Also, the service note information generator 26 may determine whether the customer is an adult or a child from an image acquired by the biological data detector 25, may detect a result of the determination as the attribute of the customer, and may generate customer service note information in consideration of the attribute of the customer. It is to be noted that the attribute of the customer detected by the service note information generator 26 is not particularly limited to the above-described example, and the age, sex, body type, which are characteristics of the customer, may be detected as attributes of the customer based on an image captured by a camera.

When the customer service note information generated by the service note information generator 26 is different from the hand-over time service note information included in the control command transmitted from the tablet 10, the service determiner 22 refers to the behavior rule storage 23, and determines a response to be provided to the customer to carry out the response content indicated by the response content information in accordance with the behavior rule information associated with the customer service note information. The service executor 24 executes a specific response determined in accordance with the behavior rule information associated with the customer service note information.

At this point, the service determiner 22 may instruct the information manager 32 via the communicators 21, 31 to update the hand-over time service note information stored in the history information storage 33 in association with the user ID to the customer service note information. Thus, the history information storage 33 may update the hand-over time service note information in the past to the latest customer service note information.

Also, the service determiner 22 determines whether or not support by the customer service person is necessary in accordance with the behavior rule information associated with the hand-over time service note information and the customer service note information. When it is determined that support by the customer service person is necessary, the service determiner 22 generates support request information indicating that support by the customer service person is necessary.

For instance, when the hand-over time service note information is “serve with care”, the behavior rule information is “serve with care, and when the customer needs anything, request for human support immediately”, and the service note information generator 26 estimates the emotion of the customer to be “anger”, the service determiner 22 determines that support by the customer service person is necessary, and generates support request information.

At this point, the communicator 21 transmits the support request information generated by the service determiner 22 to the communicator 13 of the tablet 10 via the communicator 31 of the server 30. The communicator 13 receives the support request information transmitted from the robot 20 via the server 30, and outputs the support request information to the support request information presentator 14, the support request information indicating that support by the customer service person is necessary.

The support request information presentator 14 includes a display, obtains support request information transmitted from the robot 20 via the communicator 13, and displays a support request screen on a display, the support request screen being generated using the obtained support request information. For instance, “Emergency Support Request” is displayed in large characters on the support request screen, and the customer service person looks at the display and understands that the service to the customer needs to be urgently handed over from the robot 20.

It is to be noted that the communication terminal is not particularly limited to the tablet 10, and a smartphone, or a notebook type or desktop computer may be used. Also, voice for support request may be generated using the above-mentioned support request information, and support may be requested for the customer service person by voice.

Also, the configuration of the present customer service system is not particularly limited to the above-described example, and various modifications may be made. For instance, the server 30 may be removed, but the robot 20 may be provided with the information manager 32 and the history information storage 33 so that the robot 20 also performs the processing of the server 30. In this case, the robot 20 represents an example of the customer service device.

Also, the service determiner 22, the behavior rule storage 23, and the service note information generator 26 may be removed from the robot 20, but the robot 20 may be provided with the communicator 21, the service executor 24, and the biological data detector 25. Alternatively, the server 30 may be further provided with the service determiner 22, the behavior rule storage 23, and the service note information generator 26. In this case, the communicator 21 of the robot 20 may transmit information acquired by the biological data detector 25 to the server 30. The communicator 31 of the server 30 may acquire biological data and the like, and the server 30 may perform the processing of the service determiner 22, the behavior rule storage 23, and the service note information generator 26. The service executor 24 of the robot 20 may execute a specific response based on the response determined by the service determiner 22 of the server 30. In this case, the server 30 represents an example of the customer service device.

When the server 30 operates as the customer service device, a user interface device (for instance, a display, a speaker, or a microphone) provided with the communicator 21, the service executor 24, and the biological data detector 25 may be used instead of the robot 20.

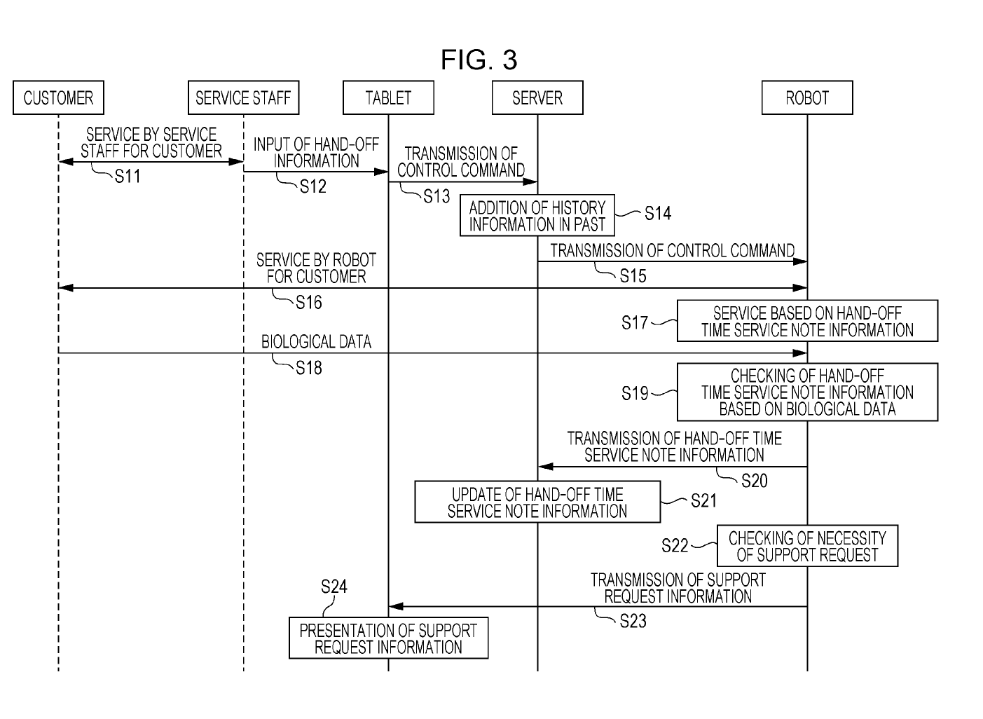

Next, the service processing performed by the customer service system configured as described above will be described. FIG. 3 is a sequence diagram illustrating an example of the service processing performed by the customer service system illustrated in FIG. 1. It is to be noted that in the following description, an example will be explained in which a human concierge as the customer service person provides response to a customer to be served in a hotel, and subsequently the response is handed over from the customer service person to the robot 20 serving as a concierge.

As illustrated in FIG. 3, the customer service person first serves the customer, for instance, receives a question from the customer, and replies to the question (step S11).

Subsequently, the customer service person determines hand-over information to be handed over to the robot 20 based on the response to the customer and the customer service person's own knowledge, and uses the hand-over information input 11 of the tablet 10 to input hand-over information including the user ID and the like of the customer, response content information indicating response content that is handed over from the customer service person to the robot 20, and hand-over time service note information that indicates a note to be considered by the robot 20 when the customer is served (step S12).

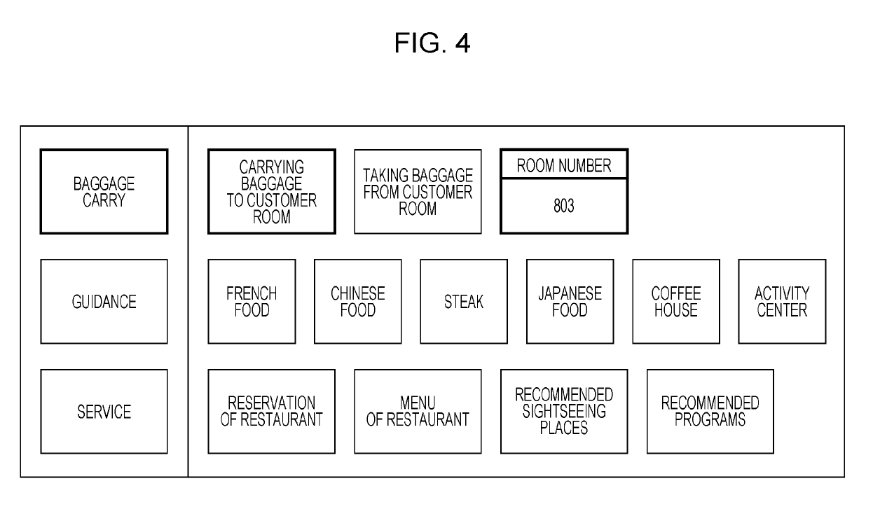

FIG. 4 is a window illustrating an example of an input screen for the customer service person to input hand-over information using the tablet 10 illustrated in FIG. 1.

As illustrated in FIG. 4, a plurality of icons showing the response content in broad categories are displayed on the left end of the screen. In the example of FIG. 4, three icons of “BAGGAGE CARRY”, “GUIDANCE” and “SERVICE” as the response content in broad categories are displayed on a touch panel of the hand-over information input 11. The customer service person taps an icon corresponding to the response content to be handed over to the robot 20.

Also, a plurality of icons showing further response content in broad categories are displayed on a central portion to the right end of the screen. For instance, for “BAGGAGE CARRY”, three icons of “CARRYING BAGGAGE TO CUSTOMER ROOM”, “TAKING BAGGAGE FROM CUSTOMER ROOM”, and “ROOM NUMBER” are displayed, and the room number of the customer is inputted below the icon of “ROOM NUMBER”.

The example of FIG. 4 is the case where the customer service person selects the icons of “BAGGAGE CARRY” and “CARRYING BAGGAGE TO CUSTOMER ROOM”, and a room number 803 of the customer is inputted below the icon of “ROOM NUMBER”. In this case, the outer frame of each selected icon is displayed with a thick line to indicate a selected state of the icon.

Also, an icon of “USER ID” similar to the icon of “ROOM NUMBER” for inputting the user ID of a customer is displayed using another operation screen (not illustrated). The customer service person inputs a user ID using the “USER ID” icon. Also, for hand-over time service note information that indicates a note to be considered by the robot 20 when a customer is served, icons such as “ATTRIBUTE IS PREMIUM CUSTOMER”, “SERVE WITH CARE”, “ARROGANT” similar to the icon of “BAGGAGE CARRY” are displayed using another operation screen (not illustrated). The customer service person selects an icon corresponding to the note to be considered by the robot 20.

As described above, using the hand-over information input 11, the customer service person can input hand-over information including the user ID and the like of the customer, response content information indicating response content that is handed over from the customer service person to the robot 20, and hand-over time service note information that indicates a note to be considered by the robot 20 when the customer is served.

Again, FIG. 3 is referred to. Next, the control command generator 12 of the tablet 10 generates a control command to control the robot 20 based on the hand-over information inputted from the hand-over information input 11. The communicator 13 transmits the control command generated by the control commands generator 12 to the communicator 31 of the server 30 (step S13).

Next, the information manager 32 of the server 30 receives an input of the control command transmitted from the tablet 10 via the communicator 21. The information manager 32 checks whether or not the history information on the user ID included in the control command is stored in the history information storage 33. When the history information on the user ID included in the control command is stored in the history information storage 33, the information manager 32 adds the history information on the user ID included in the control command to the control command (step S14). On the other hand, when the history information on the user ID included in the control command is not stored in the history information storage 33, the information manager 32 does not add the history information to the control command.

Next, the communicator 31 transmits the control command with the history information added or the control command with the history information not added, to the communicator 21 of the robot 20 (step S15).

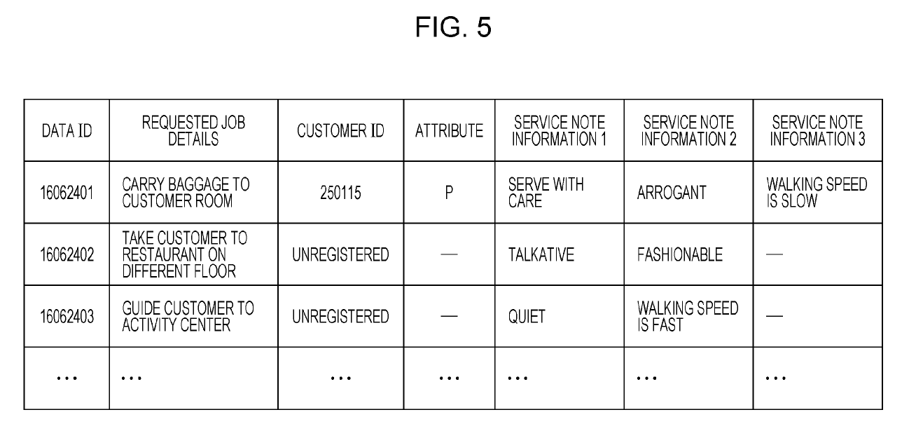

FIG. 5 is a table illustrating an example of a data structure of a control command transmitted from the tablet 10 to the robot 20 illustrated in FIG. 1.

As illustrated in FIG. 5, the control command includes a data ID for identifying the control command, content of requested work showing response content information indicating response content that is handed over from the customer service person to the robot 20, a customer ID which is a user ID, an attribute indicating attribute information of a customer, and service note information 1 to service note information 3 showing the hand-over time service note information that indicates a note to be considered by the robot 20 when the customer is served.

For instance, when the data ID is “16062401”, the content of requested work stores “CARRY BAGGAGE TO CUSTOMER ROOM”, the customer ID stores “250115”, the attribute stores “P” (premium customer), the service note information 1 stores “SERVE WITH CARE”, the service note information 2 stores “ARROGANT”, and the service note information 3 stores “WALKING SPEED IS SLOW”.

With the control command, the robot 20 executes the service of “CARRY BAGGAGE TO CUSTOMER ROOM” to the customer with a user ID of “250115” in accordance with the behavior rule “SERVE WITH CARE, AND WHEN THE CUSTOMER NEEDS ANYTHING, REQUEST FOR HUMAN SUPPORT IMMEDIATELY” associated with “SERVE WITH CARE” in the service note information 1, the behavior rule “TALK TO CUSTOMER POLITELY” associated with “ARROGANT” in the service note information 2, and the behavior rule “MOVE SLOWLY, AND DISTANCE TO CUSTOMER SHOULD BE WITHIN PREDETERMINED VALUE” associated with “WALKING SPEED IS SLOW” in the service note information 3.

Here, in the control command with the data ID of “16062401”, the attribute of “P” (premium customer) is set. For this reason, although the behavior rule “SERVE WITH CARE, AND WHEN THE CUSTOMER NEEDS ANYTHING, REQUEST FOR HUMAN SUPPORT IMMEDIATELY” associated with the service note information of “ATTRIBUTE IS PREMIUM CUSTOMER” is also applied, in the example illustrated in FIG. 2, the same behavior rule as the behavior rule of the service note information 1 is provided, and thus the behavior rules adopted by the robot 20 are the behavior rules of the service note information 1 to the service note information 3.

It is to be noted that when the behavior rule associated with the service note information of “ATTRIBUTE IS PREMIUM CUSTOMER” is different from the behavior rule associated with the service note information of “SERVE WITH CARE”, the behavior rule associated with the service note information of “ATTRIBUTE IS PREMIUM CUSTOMER” is also added.

Similarly, when the data ID is “16062402”, the content of requested work stores “TAKE CUSTOMER TO RESTAURANT ON DIFFERENT FLOOR”. The customer ID stores “UNREGISTERED” indicating that the customer has no user ID.

The attribute is blank indicating that the customer is not a premium customer. The service note information 1 stores “TALKATIVE”, the service note information 2 stores “FASHIONABLE”, and the service note information 3 is blank. In this case, similarly to the above, the robot 20 executes the response of “TAKE CUSTOMER TO RESTAURANT ON DIFFERENT FLOOR” in accordance with the behavior rules associated with the service note information 1 and the service note information 2.

Also, when the data ID is “16062403”, the content of requested work stores “GUIDE CUSTOMER TO ACTIVITY CENTER”. The customer ID stores “UNREGISTERED”. The attribute is blank. The service note information 1 stores “QUIET”, the service note information 2 stores “WALKING SPEED IS FAST”, and the service note information 3 is blank. In this case, similarly to the above, the robot 20 executes the service of “GUIDE CUSTOMER TO ACTIVITY CENTER” in accordance with the behavior rules associated with the service note information 1 and the service note information 2.

It is to be noted that the data structure of the control command is not particularly limited to the above-described example, and various modifications may be made such as setting one piece or four or more pieces of service note information rather than setting two or three pieces of service note information. Also, when multiple pieces of service note information are provided as in the above-described example, a priority order may be set to each piece of service note information. In that case, the robot 20 may preferentially adopt a behavior rule of service note information having a high priority order.

Again, FIG. 3 is referred to. Next, the communicator 21 of the robot 20 receives a control command. The robot 20 serves the customer in accordance with the control command (step S16). In this process, the processing in steps S17 to S24 described below is successively repeated as necessary.

First, when receiving a control command from the tablet 10 via the communicator 21, the service determiner 22 determines a response to be provided to the customer to carry out the response content indicated by the response content information in accordance with the behavior rule information associated with the hand-over time service note information included in the control command. The service executor 24 provides specific response based on the response determined by the service determiner 22 (step S17).

Next, the biological data detector 25 acquires the biological data of the customer (step S18). The service note information generator 26 analyzes the biological data acquired by the biological data detector 25, and thereby generates customer service note information that indicates a note to be considered by the robot 20 when the customer is served, and outputs the customer service note information to the service determiner 22. The service determiner 22 checks whether or not the customer service note information generated by the service note information generator 26 is different from the hand-over time service note information included in the control command transmitted from the tablet 10 (step S19).

Next, when the customer service note information is different from the hand-over time service note information, the service determiner 22 refers to the behavior rule storage 23, and determines a response to be provided to the customer in accordance with the behavior rule information associated with the customer service note information. The service executor 24 executes a specific response determined in accordance with the behavior rule information associated with the customer service note information. The communicator 21 transmits the customer service note information to the communicator 31 of the server 30 (step S20).

Next, the information manager 32 of the server 30 updates the hand-over time service note information stored in the history information storage 33 to the customer service note information received by the communicator 31 (step S21). It is to be noted that the above-described update processing is performed as necessary, and the processing may be omitted.

Next, the service determiner 22 checks whether or not support by the customer service person is necessary in accordance with the behavior rule information associated with the hand-over time service note information included in the control command and the customer service note information generated by the service note information generator 26 (step S22).

Next, when support by the customer service person is necessary, the service determiner 22 generates support request information indicating that support by the customer service person is necessary. The communicator 21 transmits the support request information to the communicator 31 of the server 30. The communicator 31 transmits the support request information to the communicator 13 of the tablet 10 (step S23).

Next, the support request information presentator 14 of the tablet 10 obtains support request information transmitted from the robot 20 via the communicator 13, displays on a display a support request screen generated using the obtained support request information, and presents the necessity of support for the robot 20 to the customer service person (step S24).

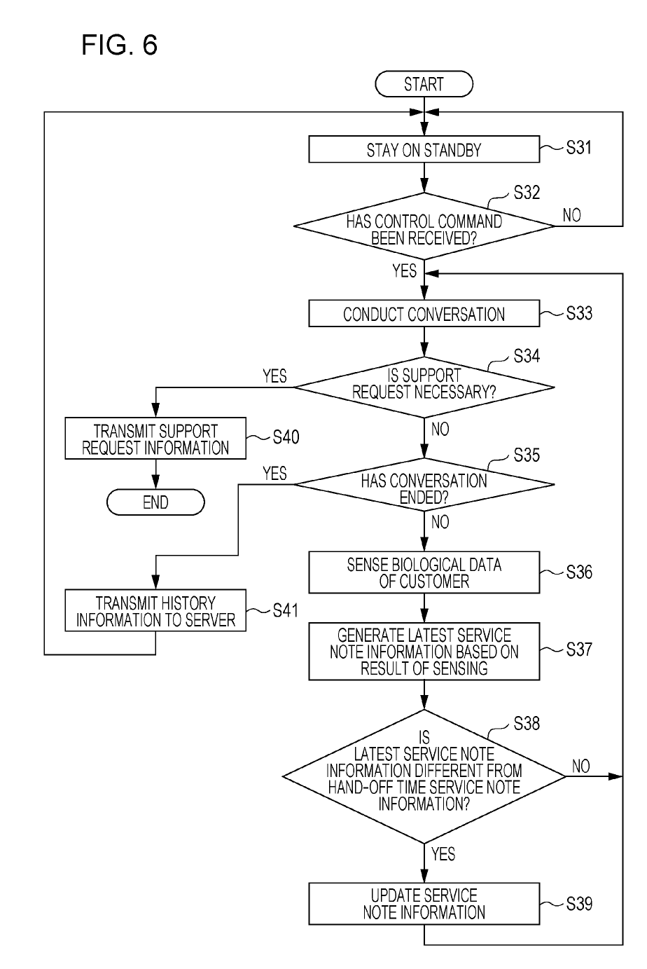

Next, the customer service hand-over processing performed by the robot 20 out of the service processing performed by the customer service system will be described in more detail. FIG. 6 is a flowchart illustrating an example of the customer service hand-over processing performed by the robot 20 illustrated in FIG. 1.

First, the robot 20 is in a standby state (step S31). At this point, the robot 20 is waiting for a hand-over instruction from a customer service person at a hotel reception desk, for instance.

Next, the service determiner 22 of the robot 20 checks whether or not a control command has been received via the communicator 21 (step S32). Here, the control command may be a control command transmitted from the tablet 10, or may be a control command to which history information is added by the server 30.

When a control command is not received (NO in step S32), the service determiner 22 continues standby processing in step S31.

On the other hand, when a control command is received (YES in step S32), the service determiner 22 determines a response to be provided to the customer to carry out the response content indicated by the response content information in accordance with the note indicated by the hand-over time service note information included in the control command. The service executor 24 provides specific response based on the response determined by the service determiner 22. For instance, the service executor 24 conducts conversation with the customer (step S33).

Next, as a result of the above-mentioned service, the service determiner 22 checks whether or not support by the customer service person is necessary (step S34). When it is determined that support by the customer service person is necessary (YES in step S34), the service determiner 22 generates support request information indicating that support by the customer service person is necessary, transmits the support request information to the communicator 13 of the tablet 10 via the communicators 21, 31 (step S40), and completes the processing. Subsequently, the robot 20 stays on standby until the customer service person comes for support.

On the other hand, when it is determined that support by the customer service person is not necessary (No in step S34), the service determiner 22 determines whether or not conversation with the customer is completed (step S35). When the conversation with the customer is completed (YES in step S35), the service determiner 22 generates history information that indicates the service history to the customer, and transmits the history information to the server 30 using the communicator 21 (step S41). Subsequently, the flow returns to the standby processing in step S31, and waits for a hand-over instruction from the next customer service person.

On the other hand, when the conversation with the customer is not completed (NO in step S35), the biological data detector 25 performs sensing of the biological data of the customer (step S36). The service note information generator 26 generates customer service note information as the latest service note information based on a result of the sensing (step S37).

Next, the service determiner 22 determines whether or not the customer service note information is different from the hand-over time service note information (step S38). When the customer service note information is the same as the hand-over time service note information (NO in step S38), the processing in and after step S33 is repeated, and conversation with the customer is continued. It is to be noted that when multiple pieces of hand-over time service note information are present, the determination in the above-mentioned step S38 is such that when the customer service note information is different from each of the pieces of hand-over time service note information, the customer service note information is determined to be different from the hand-over time service note information, and when the customer service note information is the same of any one of the pieces of hand-over time service note information, the customer service note information is determined to be the same as the hand-over time service note information.

When the customer service note information is different from the hand-over time service note information (YES in step S38), the service determiner 22 updates the current service note information to the customer service note information (step S39). Specifically, the service determiner 22 refers to the behavior rule storage 23, and determines a response to be provided to the customer in accordance with the behavior rule information associated with the customer service note information. The communicator 21 transmits the customer service note information to the communicator 31 of the server 30. The history information storage 33 updates the stored hand-over time service note information to the customer service note information.

Subsequently, the processing in and after step S33 is repeated. The service determiner 22 refers to the behavior rule storage 23, and determines a response to be provided to the customer in accordance with the behavior rule information associated with the customer service note information. The service executor 24 executes a specific response determined in accordance with the behavior rule information associated with the customer service note information.

By the above-described processing, in this embodiment, when a control command is received, which includes response content information indicating response content that is handed over from the customer service person to the robot 20, and hand-over time service note information that indicates a note to be considered by the robot 20 when the customer is served, a response to be provided to the customer is determined to carry out the response content indicated by the response content information in accordance with the note indicated by the hand-over time service note information. Therefore, the service reflecting the note determined by the customer service person in consideration of the need and intention of the customer can be provided to the customer. Thus, after the customer service person serves the customer, the subsequent response content can be smoothly handed over from the customer service person to the robot 20.

Although the customer service system according to an aspect of the present disclosure has been described based on the embodiment in the above, the present disclosure is not limited to the embodiment. The embodiments to which various alterations which will occur to those skilled in the art are made, and an embodiment constructed by a combination of components of different embodiments without departing from the spirit of the present disclosure are also included within the scope of the present disclosure.

The customer service device, the customer service method, and the customer service system according to the present disclosure, after a customer service person serves a customer, allows the subsequent response content to be smoothly handed over from the customer service person to the customer service device. Therefore, the present disclosure is useful as the customer service device, the customer service method, and the customer service system that, after a customer service person serves a customer, provide the subsequent response content handed over from the customer service person.

What is claimed is:

1. A customer service device comprising:
a communicator that receives a control command including
response content information that indicates response content to be subsequently carried out to a customer, the response content being handed over from a customer service person who has served the customer, and
first note information that indicates a first note to be considered in serving the customer; and
a service determiner that, based on the control command, determines a response to the customer so as to carry out the response content indicated by the response content information according to the first note information.

2. The customer service device according to claim 1, further comprising
a first storage that stores, in advance, the first note information and behavior rule information in association with each other, the behavior rule information indicating a behavior rule to be obeyed in serving the customer, wherein
the service determiner refers to the first storage and determines the response to the customer so as to carry out the response content indicated by the response content information according to the behavior rule information associated with the first note information included in the control command.

3. The customer service device according to claim 2, further comprising:
a biological data detector that acquires biological data of the customer; and
a generator that generates second note information that indicates a second note to be considered in serving the customer, the second note being determined by analyzing the biological data acquired by the biological data detector, wherein
the first storage stores, in advance, the second note information and the behavior rule information in association with each other, and
when the second note information is different from the first note information, the service determiner refers to the first storage and determines the response to the customer so as to carry out the response content indicated by the response content information according to the behavior rule information associated with the second note information.

4. The customer service device according to claim 3, further comprising
a second storage that stores identification information and history information in association with each other, the identification information identifying the customer, the history information including a third note information indicating a third note considered in serving the customer before, wherein
the control command further includes the identification information, and
when the second note information is different from the first note information, the service determiner replaces the third note information associated with the identification information included in the control command with the second note information.

5. The customer service device according to claim 4, further comprising
an adder that adds the history information associated with the identification information included in the control command to the control command, wherein
the service determiner determines the response to the customer so as to carry out the response content indicated by the response content information according to the behavior rule information associated with the second note information, based on the history information.

6. The customer service device according to claim 2, wherein
the control command further includes crucial condition information indicating that an attribute of the customer satisfies a predetermined crucial condition,
the first storage stores, in advance, the crucial condition information and the behavior rule information in association with each other, and
when the control command includes the crucial condition information, the service determiner refers to the first storage and determines the response to the customer to carry out the response content indicated by the response content information according to the behavior rule associated with the crucial condition information included in the control command.

7. The customer service device according to claim 2, wherein
when the service determiner determines that support by the customer service person is necessary according to the behavior rule associated with the first note information included in the control command, the service determiner generates support request information indicating necessity of the support by the customer service person, and
the communicator transmits the support request information to a communication terminal owned by the customer service person.

8. The customer service device according to claim 1, further comprising a service executor that executes the response determined by the determiner to the customer.

9. The customer service device according to claim 8, wherein the service executor executes the response to the customer by using at least one of a sound, an image, and a body movement.

10. A customer service method comprising:
receiving a control command including
response content information that includes response content to be subsequently carried out to the customer, the response content information being handed over from a customer service person who serves the customer, and
first note information that indicates a first note to be considered in serving the customer; and
determining a response to the customer so as to carry out the response content according to the first note information.

11. A customer service system comprising:
a communication terminal owned by a customer service person who serves a customer; and
a customer service device that serves the customer, wherein
the communication terminal includes
a first communicator that transmits a control command including
response content information that indicates response content to be subsequently carried out to the customer, the response content being handed over from the customer service person who has served the customer to the service device, and
first note information that includes a first note to be considered in serving the customer, and
the customer service device includes
a second communicator that receives the control command, and
a service determiner that, based on the control command, determines a response to the customer so as to carry out the response content indicated by the response content information according to the first note information.
